(19) United States
(12) Patent Application Publication
(10) Pub. No.: US 2020/0343497 A1
(43) Pub. Date: Oct. 29, 2020

(54) HOUSING OF BATTERY MODULE AND BATTERY MODULE COMPRISING THE HOUSING

(71) Applicant: Shenzhen Hello Tech Energy Co., LTD., Shenzhen City (CN)

(72) Inventors: ZHONGWEI SUN, Shenzhen City (CN); DEHUA HUANG, Shenzhen City (CN); CHAO HU, Shenzhen City (CN); ZHONGLIN WU, Shenzhen City (CN); WEI BAI, Shenzhen City (CN)

(21) Appl. No.: 16/724,156

(22) Filed: Dec. 20, 2019

(30) Foreign Application Priority Data
Apr. 23, 2019 (CN) 201910328700.6

(51) Int. Cl. H01M 2/10; H01M 10/04; H01M 10/42; E05C 1/08

(52) U.S. Cl. CPC H01M 2/1077; E05C 1/08; H01M 10/425; H01M 10/0422

(57) ABSTRACT

The disclosure provides a housing of a battery module and a battery module including the housing. The housing includes a first side plate, a second side plate, and a plurality of accommodating cavities for accommodating battery cells being defined separately between the first side plate and the second side plate; the first side plate includes a first outer surface, and a plurality of latching grooves being defined separately at the first outer surface; the second side plate includes a second outer surface, and a plurality of fixing blocks being defined separately at the second outer surface, and one fixing block is engaged with one latching groove. The fixing blocks of the housing can cooperate with the latching grooves of a next housing to achieve the detachable connection of the housings of a battery module. The number of the housing of a battery module can be increased or reduced as needed.

### TECHNICAL FIELD

The disclosure relates to the field of battery, and more particularly to a housing of a battery module and a battery module comprising the housing.

### BACKGROUND

With the development of the society and the deterioration of the environment, energy storage devices are widely used in people's life. Energy storage battery is a battery module composed of battery cells in series or in series-parallel combination. Battery modules are widely used due to their advantages of good expansibility and easy installation. In general, the battery module includes a housing to accommodate the battery cells. To gain more power, people often need to connect a plurality of housings together. A conventional method is to fix a plurality of housings together to gain more power, so that people can't increase or decrease the number of the battery cells as needed, which leads to inconvenient use.

### SUMMARY

Thus, to overcome the disadvantages of the prior art, one of the objectives of the invention is to provide a housing of a battery module to solve the problem that the number of cells of the existing battery module cannot increase or decrease as needed; the other objective is to provide a battery module comprising the housing.

One of the objectives of the disclosure is realized by adopting the following technical scheme.

A housing of a battery module comprises a first side plate, a second side plate, and a plurality of accommodating cavities for accommodating battery cells being defined separately between the first side plate and the second side plate; the first side plate comprises a first outer surface, and a plurality of latching grooves being defined separately at the first outer surface; the second side plate comprises a second outer surface, and a plurality of fixing blocks being defined separately at the second outer surface, and one fixing block is engaged with one latching groove.

As an improvement, each of the plurality of the fixing blocks comprises a connection portion and a clamping portion; the connection portion comprises a first end connected to the second side plate and a second end opposite to the first end and connected to the clamping portion; the clamping portion comprises two symmetrical slopes connected to the second end of the connection portion.

As an improvement, the housing further comprises an upper enclosure and a lower enclosure connected to a bottom end of the upper enclosure through screws; the first side plate of the upper enclosure and/or the lower enclosure comprise the plurality of latching grooves, and the second side plate of the upper enclosure and/or the lower enclosure comprise the plurality of fixing blocks corresponding to the plurality of latching grooves

As an improvement, the upper enclosure comprises a plurality of first cavities, and the plurality of the first cavities are defined separately at the upper enclosure; the lower enclosure comprises a plurality of second cavities which is aligned to the plurality of first cavities one by one; the first cavities and the second cavities are arranged in rows and columns, and the first cavities and the second cavities are combined to form the plurality of accommodating cavities.

As an improvement, a sectional area of a top part of the plurality of first cavities is less than a sectional area of a bottom part of the plurality of first cavities, and a cross section of the top part of the plurality of first cavities is circular, a cross section of the bottom part of the plurality of first cavities is square; a sectional area of a top part of the plurality of second cavities is larger than a sectional area of a bottom part of the plurality of second cavities, and a cross section of the top part of the plurality of second cavities is square, a cross section of the bottom part of the plurality of second cavities is circular.

As an improvement, the upper enclosure comprises an upper surface, a plurality of locating rods are disposed separately at the upper surface and extend upwards, and each locating rod is provided with a nut for fixing a battery management system; the lower enclosure comprises a bottom surface provided with a plurality of locating holes aligning with the plurality of locating rods respectively.

As an improvement, the upper surface of the upper enclosure and the lower surface of the lower enclosure comprise a plurality of protrusions corresponding to connection holes of a nickel strap, and the plurality of protrusions are disposed separately.

As an improvement, the housing further comprises a mounting hole for mounting an inverter board.

As an improvement, the housing further comprises a sleeve and a bolt; the sleeve is detachably disposed in the mounting hole, and the bolt passes through the inverter board and is connected to the sleeve to fix the inverter board on the sleeve.

As an improvement, the first side plate and/or the second side plate comprise a mounting plate to fix the housing on an external device, and the mounting plate comprises a plurality of through holes to receive fasteners.

Another objective of the disclosure is realized by adopting the following technical scheme.

A battery module comprises a battery cell module, a nickel strap, and the at least one housing mentioned above; the battery cell module comprises a plurality of battery cells disposed in the accommodating cavities of the housing, and the nickel strap is fixed on the housing and is electrically connected to the plurality of battery cells.

As an improvement, the housing comprises an upper surface and a bottom surface, the nickel strap is fixed on the upper surface and the bottom surface of the housing.

Compared with the related art, the housing of the disclosure has the following advantages: the first side plate comprises the latching grooves, and the second side plate comprises the fixing blocks. The fixing blocks of a housing can cooperate with the latching grooves of a next housing to achieve the detachable connection of the housings of a battery module. Thus, according to the actual needs, the number of the housing of a battery module can be increased or reduced, to achieve the effect of flexible control of the number of battery cells, which is convenient for use.

### BRIEF DESCRIPTION OF THE DRAWINGS

FIG. 1 is an assembled view of a housing of a battery module according to one embodiment of the discourse.

FIG. 2 is a schematic diagram of three assembled housings of the battery module according to one embodiment of the discourse.

FIG. 3 is an exploded, isometric view of the housing of FIG. 1.

FIG. 4 is another assembled view of the housing of FIG. 1.

FIG. 5 is an enlarged view of a part A of FIG. 4.

In the drawings, the following reference numbers are used: 100. Housing; 10. First side plate; 20. Second side plate; 11. Latching groove; 21. Fixing block; 211. Connection portion; 212. Clamping portion; 213. Slope; 30. Upper enclosure; 40. Lower enclosure; 31. First cavity; 41. Second cavity; 32. Locating rod; 42. Locating hole; 33. Mounting hole; 43. Protrusion; 50. Mounting plate; 51. Through hole; 60. Sleeve; 70. Bolt.

### DETAILED DESCRIPTION OF THE PREFERRED EMBODIMENTS

In order to make the objects, technical solutions and advantages of the disclosure much clear, the disclosure will be described in greater detail with reference to the combination of the embodiments and the drawings. It should be noted that the embodiments described herein are merely illustrative of the disclosure and do not limit the scope of the present disclosure.

It should be noted that all directional indications (such as up, down, left, right, front, rear, inside, outside, top, bottom, . . . ) in the embodiment of the disclosure are only used to explain the relative position relationship among the components under a certain attitude (as shown in the attached figure), etc., if the specific attitude changes, the directional indications will change accordingly.

It should also be noted that when a component is called “fixed on” or “disposed on” another component, the component can be directly connected to the another component or there may be one or more intermediate components therebetween. When a component is referred to as “connecting to” another component, it can be directly connected to the another component or there may be one or more intermediate components therebetween.

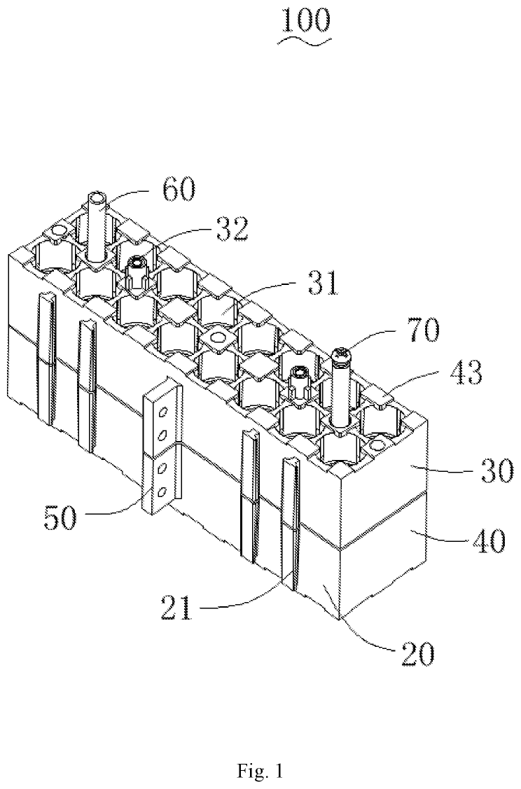

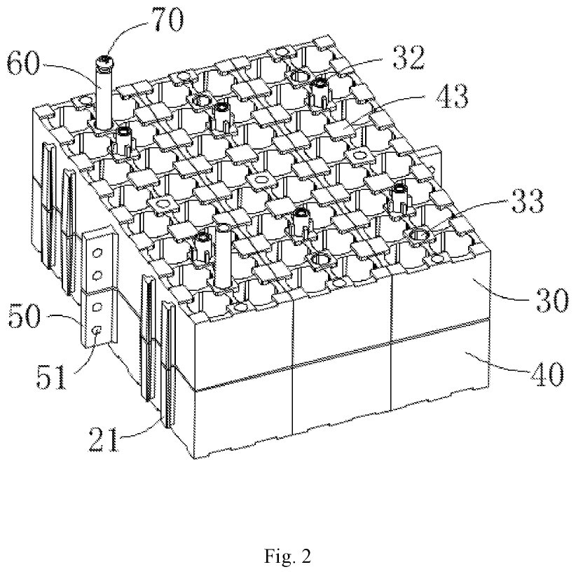

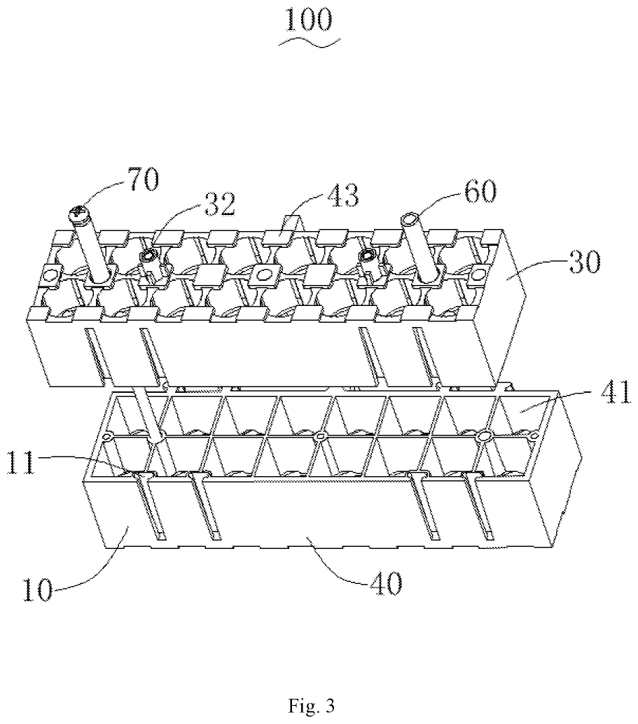

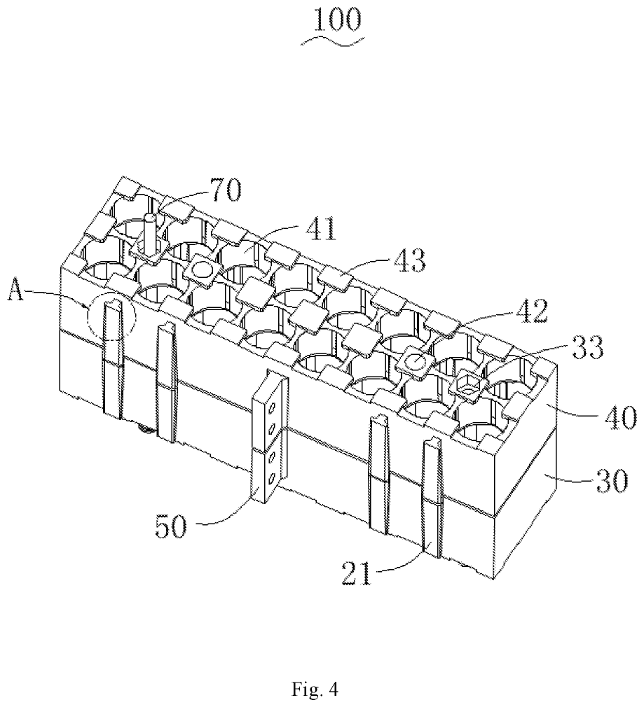

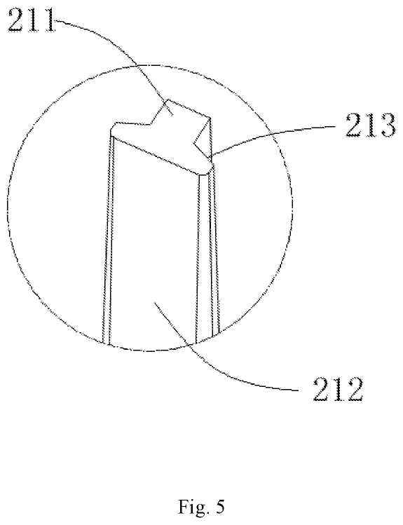

As shown in FIGS. 1-5, the disclosure provides a housing 100 of a battery module (not shown) comprising a first side plate 10 and a second side plate 20 opposite to the first side plate 10. A plurality of accommodating cavities is defined separately between the first side plate 10 and the second side plate 20 for accommodating battery cells. The first side plate 10 comprises a first outer surface, and a plurality of latching grooves 11 being defined separately at the first outer surface. The second side plate 20 comprises a second outer surface, and a plurality of fixing blocks 21 being defined separately at the second outer surface. The plurality of fixing blocks 21 is corresponding to the plurality of spaced groove 11 in shape, and one fixing block 21 is engaged with one latching groove 11. By this design, i.e., the first side plate 10 comprises the latching grooves 11, and the second side plate 20 comprises the fixing blocks 21. The fixing blocks 21 can cooperate with the latching grooves 11 of another housing of a battery module, thus achieving the detachable connection of the housing 100 of a battery module. Thus, according to the actual needs, people can increase or reduce the number of the housing 100 of a battery module accordingly, to achieve the effect of flexible control of the number of battery cells, which is convenient for use. In addition, the housing 100 comprises a plurality of accommodating cavities, when one battery cell breaks down, other battery cells are not affected and can still work, which improves the reliability of the battery module comprising the housing 100. Specifically, in this embodiment, the housing 100 is made of plastic material.

Preferably, each of the plurality of the fixing blocks 21 comprises a connection portion 211 and a clamping portion 212; the connection portion 211 comprises a first end connected to the second side plate 20 and a second end opposite to the first end and connected to the clamping portion 212; the clamping portion 212 comprises two symmetrical slopes 213 connected to the second end of the connection portion 211. The latching grooves 11 are corresponding to the fixing blocks 21 in shape, and one fixing block 21 is engaged with one latching groove 11. By this design, i.e., each fixing block 21 comprises a connection portion 211 and a clamping portion 212, the clamping portion 212 comprises two symmetrical slopes 213 connected to the second end of the connection portion, and one fixing block 21 is engaged with one latching groove 11, the slopes 213 can guide the fixing blocks 21 to slide into the latching grooves 11, thus facilitating the assembly and disassembly of the housing 100.

Preferably, the housing 100 comprises an upper enclosure 30 and a lower enclosure 40 connected to a bottom end of the upper enclosure 30 through screws; the first side plate 10 of the upper enclosure 30 and/or the lower enclosure 40 comprise the plurality of latching grooves 11, and the plurality of latching grooves 11 are defined separately; the second side plate 20 of the upper enclosure 30 and/or the lower enclosure 40 comprise the plurality of fixing blocks 21, and the plurality of fixing blocks 21 are disposed separately, and one fixing block 21 is engaged with one latching groove 11. Specifically, in this embodiment, the first side plate 10 of the upper enclosure 30 and the first side plate 10 of the lower enclosure 40 both comprise the plurality of latching grooves 11, and the plurality of latching grooves 11 are defined separately; the second side plate 20 of the upper enclosure 30 and the second side plate 20 of the lower enclosure 40 both comprise the plurality of fixing blocks 21, and the plurality of fixing blocks 21 are disposed separately, and one fixing block 21 is engaged with one latching groove 11, thus improving the stability of the housings 100. Optionally, it is practicable that only the first side plate 10 of the upper enclosure 30 or the lower enclosure 40 comprises the plurality of latching grooves 11, and only the second side plate 20 of the upper enclosure 30 or the lower enclosure 40 comprises the plurality of fixing blocks 21.

Preferably, in this embodiment, the upper enclosure 30 is connected to the lower enclosure 40 via tapping screws. In this way, bolts or nuts are not needed in the connection between the upper enclosure 30 and the lower enclosure 40, which facilitates the connection and saves the production cost. Optionally, in practical application, the upper enclosure 30 and the lower enclosure 40 can also be connected by other mechanical means or directly glued and fixed.

Preferably, in this embodiment, the first side plate 10 of the upper enclosure 30 and the first side plate 10 of the lower enclosure 40 both comprise four latching grooves 11, and the second side plate 20 of the upper enclosure 30 and the second side plate 20 of the lower enclosure 40 both comprise four fixing blocks 21. The design can improve the stability of the housings 100. Optionally, the number of the latching grooves of the first side plate 10 of the upper enclosure 30 and the first side plate 10 of the lower enclosure 40 is not limited to four, the number of the fixing blocks 21 of the second side plate 20 of the upper enclosure 30 and the second side plate 20 of the lower enclosure 40 is not limited to four, for example, one, two or other numbers are acceptable.

Preferably, the upper enclosure 30 comprises a plurality of first cavities 31, and the plurality of first cavities 31 are defined separately and the lower enclosure 40 comprises a plurality of second cavities 41 which is aligned to the plurality of first cavities 31 one by one; the first cavities 31 and the second cavities 41 are arranged in rows and columns; and the first cavities 31 and the second cavities 41 are combined to form the plurality of accommodating cavities. By this design, that is, the upper enclosure 30 is provided with a plurality of first cavities 31, and the lower enclosure 40 is provided with a plurality of second cavities 41, and the first cavities 31 and the second cavities 41 are combined to form the plurality of accommodating cavities. This is convenient to put the battery cells into the accommodating cavities. Because the first cavities 31 and the second cavities 41 both are spaced with one another, the accommodating cavities formed by the first cavities 31 and the second cavities 41 are independent from each other.

Preferably, the sectional area of the top part of the plurality of first cavities 31 is less than the sectional area of the bottom part of the plurality of first cavities 31, and the cross section of the top part of the plurality of first cavities 31 is circular, the cross section of the bottom part of the plurality of first cavities 31 is square; the sectional area of the top part of the plurality of second cavities 41 is larger than the sectional area of the bottom part of the plurality of second cavities 41, and the cross section of the top part of the plurality of second cavities 41 is square, the cross section of the bottom part of the plurality of second cavities 41 is circular. By this design, that is, the top part of the plurality of first cavities 31 and the bottom part of the plurality of second cavities 41 are circular openings, and the bottom part of the plurality of first cavities 31 and the top part of the plurality of second cavities 41 are square openings; the circular openings can fix the battery cells and prevent the battery cells from shaking in the accommodating cavities. The section area of the square openings is larger than that of the circular openings, thus, when the battery cells are placed in the accommodating cavities, a gap is formed in the middle wall of the accommodating cavities, which is conducive to the heat dissipation of the battery cells, thus improves the service life of the battery cells.

Preferably, the upper enclosure 30 comprises an upper surface, a plurality of locating rods 32 are disposed separately at the upper surface and extend upwards; the lower enclosure 40 comprises a bottom surface provided with a plurality of locating holes 42 aligning with the plurality of locating rods 32 respectively. By this design, that is, the upper surface of the upper enclosure 30 is provided with a plurality of locating rods 32, and the plurality of locating rods 32 are disposed separately, the bottom surface of the lower enclosure 40 is provided with a plurality of locating holes 42, and the plurality of locating holes 42 are defined separately; the locating rods 32 can insert into the locating holes 42, thus achieving the vertical superposition of the housings 100, improving the use flexibility. Specifically, in this embodiment, two locating rods 32 are provided. This improves the stability of the connection between the housings 100. Optionally, in use, the number of the locating rods 32 is not limited to two, for example, one or more locating rods are also practicable.

Preferably, in this embodiment, each locating rod 32 is provided with a nut for fixing a battery management system. The bolt and nut cooperate to install the battery management system on the locating rod 32. By the design of the battery management system, the overcharge or over discharge of the battery module can be prevented, thus improving the reliability of the product.

Preferably, the housing 100 further comprises a mounting hole 33 for mounting an inverter board. By this design, that is, the upper enclosure 30 is provided with a mounting hole 33 for mounting an inverter board, the battery module can convert a direct current power having a low-voltage into an alternating current power having a voltage of 220 V.

Preferably, the housing further comprises a sleeve 60 and a bolt 70; the sleeve 60 is detachably disposed in the mounting hole 33, and the bolt 70 passes through the inverter board and is connected to the sleeve 60 to fix the inverter board on the sleeve 60. The design simplifies the connection of the sleeve 60 and the bolt 70, and facilitates the installation of the inverter board. Because the sleeve 60 is detachably installed in the mounting hole 33, when a plurality of housings 100 requires installation vertically, the redundant sleeves 60 can be dismounted.

Preferably, the upper surface of the upper enclosure 30 and the lower surface of the lower enclosure 40 comprise a plurality of protrusions 43 corresponding to the connection holes of a nickel strap. By this design, that is, the upper surface of the upper enclosure 30 and the lower surface of the lower enclosure 40 are provided with protrusions 43, so that the nickel strap can be electrically connected to a plurality of battery cells to obtain more power. The nickel strap is provided with the connection holes corresponding to protrusions 43, and one connection hole is engaged with protrusions 43, the cooperation of the connection holes and the protrusions 43 can effectively fix the nickel strap on the housing 100. Specifically, the protrusions 43 are square. Optionally, the shape of the protrusions 43 is not limited to square, for example, circle or oval is acceptable.

Preferably, in this embodiment, the locating rods 32 are disposed on the protrusions 43 which are square. The corners of the square protrusions 43 extend to the upper or lower part of the accommodating cavities, to prevent the escape of the battery cells from the accommodating cavities.

Preferably, the first side plate 10 and/or the second side plate 20 comprise a mounting plate 50 to fix the housing 100 on an external device, and the mounting plate 50 comprises a plurality of through holes 51 to receive fasteners. Specifically, in this embodiment, the first side plates 10 of the upper enclosure 30 and the lower enclosure 40 and the second side plates 20 of the upper enclosure 30 and the lower enclosure 40 are both provided with the mounting plates 50, thus improving the connection stability of the housing 100 and an external device. The mounting plates 50 are detachably connected to the first side plates 10 and the second side plates 20. When a plurality of housings 100 are horizontally connected, the mounting plates 50 are disposed only on the outermost first side plate 10 and the outermost second side plate 20, and the mounting plates 50 on other first and second side plates can be removed.

The disclosure also provides a battery module, the battery module comprises a battery cell module, a nickel strap, and the at least one housing described above. The battery cell module comprises a plurality of battery cells disposed in the accommodating cavities of the housing, and the nickel strap is fixed on the upper surface and the bottom surface of the housing and is electrically connected to the plurality of battery cells. The battery module comprises the housing with a plurality of accommodating cavities, so that the number of the battery cells is controllable, thus controlling the capacitance of the battery module. Specifically, in this embodiment, the battery cells are preferably a lithium battery with high capacitance, long service life and environmental friendliness.

Advantage of the housing are summarized as follows: the latching grooves 11 of a housing cooperate with the fixing blocks 21 of a next housing to achieve the horizontal connection of the housings 100 of the battery module, the locating rod 32 of a housing cooperate with the locating hole 42 of a next housing to achieve the vertical connection of the housings 100 of the battery module. Thus, the number of battery cells can be flexibly controlled so that the capacity of the battery module can be flexibly controlled according to the actual needs.

The above embodiments are only the preferred embodiments of the present disclosure, and do not limit the scope of the present disclosure. A person skilled in the art may make various other corresponding changes and deformations based on the described technical solutions and concepts. And all such changes and deformations shall also fall within the scope of the present disclosure.

What is claimed is:

1. A housing of a battery module, comprising:
a first side plate;
a second side plate; and
a plurality of accommodating cavities for accommodating battery cells being defined separately between the first side plate and the second side plate;
wherein the first side plate comprises a first outer surface, and a plurality of latching grooves being defined separately at the first outer surface; the second side plate comprises a second outer surface, and a plurality of fixing blocks being defined separately at the second outer surface, and one fixing block is engaged with one latching groove.

2. The housing of claim 1, wherein each of the plurality of the fixing blocks comprises a connection portion and a clamping portion; the connection portion comprises a first end connected to the second side plate and a second end opposite to the first end and connected to the clamping portion; the clamping portion comprises two symmetrical slopes connected to the second end of the connection portion.

3. The housing of claim 1, further comprising an upper enclosure and a lower enclosure connected to a bottom end of the upper enclosure through screws; the first side plate of the upper enclosure and/or the lower enclosure comprise the plurality of latching grooves, and the second side plate of the upper enclosure and/or the lower enclosure comprise the plurality of fixing blocks corresponding to the plurality of latching grooves.

4. The housing of claim 3, wherein the upper enclosure comprises a plurality of first cavities, and the plurality of the first cavities are defined separately at the upper enclosure; the lower enclosure comprises a plurality of second cavities which is aligned to the plurality of first cavities one by one; the first cavities and the second cavities are arranged in rows and columns, and the first cavities and the second cavities are combined to form the plurality of accommodating cavities.

5. The housing of claim 4, wherein a sectional area of a top part of the plurality of first cavities is less than a sectional area of a bottom part of the plurality of first cavities, and a cross section of the top part of the plurality of first cavities is circular, a cross section of the bottom part of the plurality of first cavities is square; a sectional area of a top part of the plurality of second cavities is larger than a sectional area of a bottom part of the plurality of second cavities, and a cross section of the top part of the plurality of second cavities is square, a cross section of the bottom part of the plurality of second cavities is circular.

6. The housing of claim 3, wherein the upper enclosure comprises an upper surface, a plurality of locating rods are disposed separately at the upper surface and extend upwards, and each locating rod is provided with a nut for fixing a battery management system; the lower enclosure comprises a bottom surface provided with a plurality of locating holes aligning with the plurality of locating rods, respectively.

7. The housing of claim 6, wherein both of the upper surface of the upper enclosure and the lower surface of the lower enclosure comprise a plurality of protrusions corresponding to connection holes of a nickel strap, and the plurality of protrusions are disposed separately.

8. The housing of claim 1, further comprising a mounting hole for mounting an inverter board.

9. The housing of claim 8, further comprising a sleeve and a bolt; the sleeve is detachably disposed in the mounting hole, and the bolt passes through the inverter board and is connected to the sleeve to fix the inverter board on the sleeve.

10. The housing of claim 1, wherein the first side plate and/or the second side plate comprise a mounting plate to fix the housing on an external device, and the mounting plate comprises a plurality of through holes to receive fasteners.

11. A battery module, comprising:
a battery cell module;
a nickel strap; and
at least one housing of claim 1;
wherein the battery cell module comprises a plurality of battery cells disposed in the accommodating cavities of the housing, and the nickel strap is fixed on the housing and is electrically connected to the plurality of battery cells.

12. The battery module of claim 11, wherein the housing comprises an upper surface and a bottom surface, the nickel strap is fixed on the upper surface and the bottom surface of the housing.

13. The battery module of claim 11, wherein each of the plurality of the fixing blocks comprises a connection portion and a clamping portion; the connection portion comprises a first end connected to the second side plate and a second end opposite to the first end and connected to the clamping portion; the clamping portion comprises two symmetrical slopes connected to the second end of the connection portion.

14. The battery module of claim 11, further comprising an upper enclosure and a lower enclosure connected to a bottom end of the upper enclosure through screws; the first side plate of the upper enclosure and/or the lower enclosure comprise the plurality of latching grooves, and the second side plate of the upper enclosure and/or the lower enclosure comprise the plurality of fixing blocks corresponding to the plurality of latching grooves.

15. The battery module of claim 14, wherein the upper enclosure comprises a plurality of first cavities, and the plurality of the first cavities are defined separately at the upper enclosure; the lower enclosure comprises a plurality of second cavities which is aligned to the plurality of first cavities one by one; the first cavities and the second cavities are arranged in rows and columns, and the first cavities and the second cavities are combined to form the plurality of accommodating cavities.

16. The battery module of claim 15, wherein a sectional area of a top part of the plurality of first cavities is less than a sectional area of a bottom part of the plurality of first cavities, and a cross section of the top part of the plurality of first cavities is circular, a cross section of the bottom part of the plurality of first cavities is square; a sectional area of a top part of the plurality of second cavities is larger than a sectional area of a bottom part of the plurality of second cavities, and a cross section of the top part of the plurality of second cavities is square, a cross section of the bottom part of the plurality of second cavities is circular.

17. The battery module of claim 14, wherein the upper enclosure comprises an upper surface, a plurality of locating rods are disposed separately at the upper surface and extend upwards, and each locating rod is provided with a nut for fixing a battery management system; the lower enclosure comprises a bottom surface provided with a plurality of locating holes aligning with the plurality of locating rods respectively.

18. The battery module of claim 17, wherein both of the upper surface of the upper enclosure and the lower surface of the lower enclosure comprise a plurality of protrusions corresponding to connection holes of the nickel strap, and the plurality of protrusions are disposed separately.

19. The battery module of claim 11, further comprising a mounting hole for mounting an inverter board.

20. The battery module of claim 19, further comprising a sleeve and a bolt; the sleeve is detachably disposed in the mounting hole, and the bolt passes through the inverter board and is connected to the sleeve to fix the inverter board on the sleeve.
